(19) United States
(12) Patent Application Publication
(10) Pub. No.: US 2005/0134479 A1
(43) Pub. Date: Jun. 23, 2005

(54) Vehicle display system

(76) Inventors: Kazuyoshi Isaji, Kariya-city (JP); Naohiko Tsuru, Handa-city (JP); Takahiro Wada, Takamatsu-city (JP); Hiroshi Kaneko, Okayama-City (JP)

Correspondence Address: HARNESS, DICKEY & PIERCE, P.L.C., P.O. BOX 828, BLOOMFIELD HILLS, MI, 48303, US

(21) Appl. No.: 11/010,731

(22) Filed: Dec. 13, 2004

(30) Foreign Application Priority Data
Dec. 17, 2003 (JP) 2003-420006

(51) Int. Cl. G08G 1/00

(52) U.S. Cl. 340/901; 340/425.5; 340/995.24; 340/435; 348/148; 382/181; 345/7; 345/633

(57) ABSTRACT

A vehicle display system recognizes, from within a color image of a forward scenery of a subject vehicle, an object such as left and right brake lights of a leading vehicle or a halt sign, each of which includes a red light element. Of the recognized object, a given position on a display area in a windshield of the subject vehicle is extracted. The extracted given position is then highlighted on the display area so that a user of the subject vehicle can properly recognize the object including the red light element.

### CROSS REFERENCE TO RELATED APPLICATIONS

This application is based on and incorporates herein by reference Japanese Patent Application No. 2003-420006 filed on Dec. 17, 2003.

### FIELD OF THE INVENTION

The present invention relates to a display system used in a vehicle including an automobile.

### BACKGROUND OF THE INVENTION

Conventionally, there is proposed a driving assistance system that is used for indicating information relating to a periphery, to a driver of a vehicle (e.g., Patent document 1). In Patent document 1, when it is determined that a driver misses looking at a road sign, a driving assistance system designates information relating to the not seen road sign, to inform the driver of the designated information.

Generally, an urban area has more road signs than a suburban area. When a driver pays attention to a pedestrian or another vehicle during the driving in the urban area, the driver cannot sufficiently observe the peripheral road signs. Here, the conventional driving assistance system outputs all the information that the driver did not look at, so that the driver may not recognize the road sign important to the driving.
Patent document 1: JP-H6-251287 A

### SUMMARY OF THE INVENTION

It is an object of the present invention to provide a vehicle display system capable of properly indicating peripheral information that is important to a driver on driving.

To achieve the above object, a vehicle display system is provided with the following. A color image of a forward scenery ahead of a vehicle is taken. An object including a red light element in the taken color image of the forward scenery is detected. An object corresponding to at least one of a leading vehicle, a road sign, and a traffic control apparatus is recognized. Of the red light element of the recognized object, a first position on the taken color image of the forward scenery is extracted. An eye point of a user of the vehicle is detected. A second position that is located on a display area in a windshield of the vehicle and corresponds to the extracted first position of the red light element is designated based on the detected eye point. A display image that is used to highlight the designated second position over the forward scenery is generated. The generated display image is displayed at the designated second position on the display area so that the displayed image is superimposed on the forward scenery. The user is thereby caused to recognize the display image.

In this structure, a driver is provided with a red light element that indicates information important to driving. The red light element is included in lighting of brake lights of a leading vehicle, a road sign such as a halt sign or a do-not-enter sign, or a red traffic signal of a traffic control apparatus. This possibly results in preventing a driver of the subject vehicle from missing recognizing the important information.

As another aspect of the present invention, a vehicle display system is provided with the following. A color image of a forward scenery ahead of a vehicle is taken. An object including a red light element in the taken color image of the forward scenery is detected. Of the detected object, an object corresponding to at least one of a leading vehicle, a road sign, and a traffic control apparatus is recognized. Of the red light element of the recognized object, a first position on the taken color image of the forward scenery is extracted. A display image used to highlight the extracted first position over the forward scenery within the color image is generated. The taken color image and the generated display image are displayed so that the generated display image is superimposed over the extracted first position on the displayed color image.

In this structure, a color image of a forward scenery and also a generated display image are displayed by being superimposed with each other on a head-up display or a display disposed in a center console of the vehicle. A driver thereby properly recognizes the displayed images, also resulting in preventing of missing recognizing the important information.

### BRIEF DESCRIPTION OF THE DRAWINGS

The above and other objects, features, and advantages of the present invention will become more apparent from the following detailed description made with reference to the accompanying drawings. In the drawings:

FIG. 1 is a diagram of a schematic overall structure of a vehicle display system according to an embodiment of the present invention;

FIG. 2 is a block diagram of an internal structure of a control unit of the vehicle display system;

FIG. 3 is an example of a photographed RGB color image of a forward scenery ahead of a vehicle;

FIG. 4 is an example of an image where red light elements that are included in brake lights of a leading vehicle (LV), a halt sign (SG), and a barrier wall (BA) painted in red are detected;

FIG. 5 is an example of an image where a left brake light (LVL) of a leading vehicle, a right brake light (LVR) of the leading vehicle, and a halt sign (SG) are recognized;

FIG. 6 is an example of an image where a left brake light (LVL) of a leading vehicle, a right brake light (LVR) of the leading vehicle, and a halt sign (SG) are highlighted;

FIG. 7 is a flow chart diagram of a process of a vehicle display system according to the embodiment;

FIG. 8 is a schematic view showing a combination (r, g, b) of three primary colors, i.e., red (R), green (G), and, blue (B); and

FIG. 9 is an example of an image where a halt sign (SG) is magnified, according to a modification 2 of the embodiment.

### DETAILED DESCRIPTION OF THE PREFERRED EMBODIMENTS

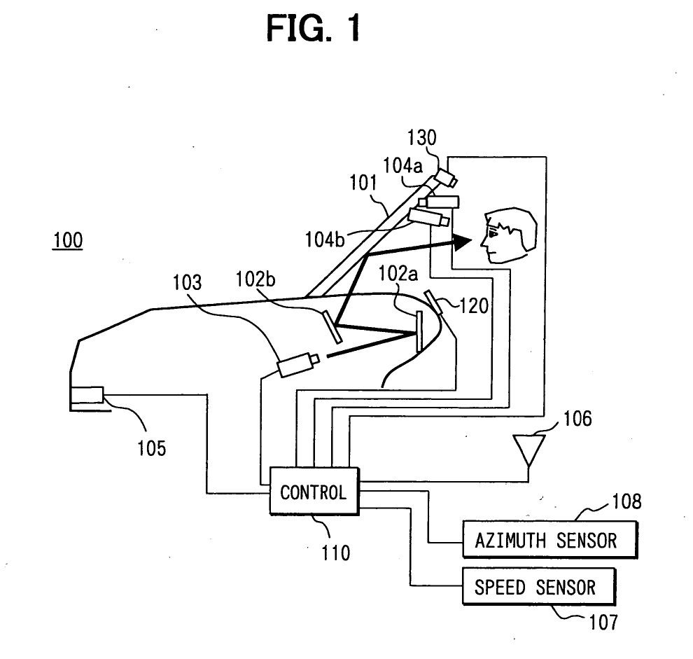

The present invention is directed to as an embodiment a vehicle display system 100 whose overall structure is shown in FIG. 1. The system 100 includes a windshield 101 of a (subject) vehicle; mirrors 102a, 102b, a projector 103, cameras 104a, 104b; a laser radar 105; a GPS antenna 106; a vehicle speed sensor 107; an azimuth sensor 108; and a control unit 110.

The windshield 101 is a front window and provided with a surface treatment in its surface facing a cabin of the vehicle, the treatment which functions as a combiner. This surface-treated area is designed to become a display area where a display light outputted from the projector 103 is projected. That is, a known display area of a head-up display is designed to be located on the windshield 101. An occupant of the vehicle seated on a driver seat can thereby see the display image projected on the display area by the light outputted from the projector 103 so that the display image is superimposed on a real forward scenery ahead of the subject vehicle.

The mirrors 102a, 102b are reflection plates that introduce the display light outputted from the projector 103 to the windshield 101. The mirrors 102a, 102b can be adjusted in their inclination angles based on an instruction signal from the control unit 110. The projector 103 obtains image data from the control unit 110, converts the image data to a display light, and outputs the display light. The outputted display light is projected on the display area on the windshield 101.

The camera 104a is an optical camera used as a photographing unit that photographs a forward area ahead of the subject vehicle, to output to the control unit 110 a photographing image signal including: image vertical and horizontal synchronization signals; and an RGB color signal indicating a color of each of pixels of the image. The RGB color signal indicates a color of each of pixels of the image by combining (r, g, b) three primary colors of red (R), green (G), and blue (B) as shown in FIG. 8.

For instance, when an eight bit element (0 to 255) is assigned to represent each color, a total of 24 bits formed of each eight bit of the three primary colors can represent 16,777,216 colors. When each color is 255, a pure white is outputted. By contrast, when each color is 0 (zero), a pure black is represented.

The camera 104b is formed of, e.g., a CCD camera to detect an eye point of the user of the subject vehicle based on the image photographed by the camera 104b.

The laser radar 105 measures, of an object that reflects the radiated laser light, a distance, a relative speed, or a lateral bias that measures from a subject-vehicle center in a subject-vehicle width direction by radiating laser light to a given range ahead of the subject vehicle. The measurement results are converted to electric signals and then outputted to the control unit 110.

The GPS antenna 106 receives radio waves transmitted from the known GPS (Global Positioning System) satellites, and outputs the received signals as electric signals to the control unit 110.

The vehicle speed sensor 107 detects a speed of the subject vehicle, so that detection results are outputted to the control unit 110.

The azimuth sensor 109 is formed of a known geomagnetism sensor or gyroscope to detect an absolute advancing orientation of the subject vehicle and an acceleration generated in the subject vehicle to output them to the control unit 110 as electric signals.

The control unit 110 generates a display image that is to be displayed on a display area designed on the windshield 101, primarily based on a signal from the cameras 104a, 104b and outputs image data of the generated display image to the projector 103.

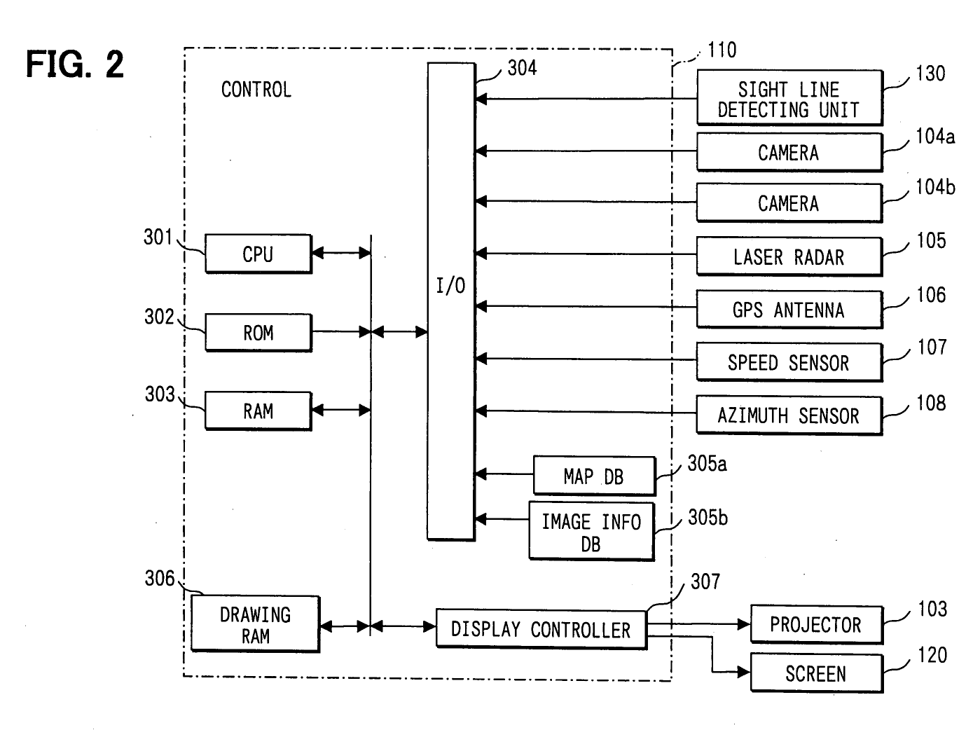

As shown in FIG. 2, the control unit 110 includes a CPU 301, a ROM 302, a RAM 303, an input and output unit 304, a map database 305a, an image information database 305b, a drawing RAM 306, and a display controller 307.

The CPU 301, the ROM 302, the RAM 303, and the drawing RAM 306 are formed of a known processor and memory module, where the CPU 301 uses the RAM 303 as a temporary storage that temporarily stores data and executes various processings based on a program stored in the ROM 302. Further, the drawing RAM 306 stores image data to be outputted to the projector 103.

The input and output unit 304 functions as an interface. The input and output unit 304 is inputted with signals from the cameras 104a, 104b, the laser radar 105, the GPS antenna 106, the speed sensor 107, the azimuth sensor 108, and various data from the map database 305a, the image information database 305b; further, the unit 304 outputs the inputted signals and various data to the CPU 301, the RAM 303, the drawing RAM 306, and the display controller 307.

The map database 305a is a storage that stores map data formed of road-related data such as road signs and traffic control apparatuses, and facility-related data. The map database 305b uses as a storage a CD-ROM, a DVD-ROM etc. because of its data volume; however, a rewritable storage such as a memory card or a hard disk can be used as the storage. Here, the road-related data includes positions and kinds of the road signs; and setting-positions, kinds, and shapes of the traffic control apparatuses in the intersections.

The image information database 305b is a storage that stores display image data to be used when the display image is generated so as to output to the drawing RAM 306. The display controller 307 reads out the image data stored in the drawing RAM 306, and outputs the read image data to the projector 103 after computing a display position so that the display image can be displayed in a proper position on the windshield.

Further, the vehicle display system 100 of this embodiment, detects objects that have red light elements from among the RGB image of the forward scenery of the subject vehicle taken by the camera 104a. Of the detected objects having the red light elements, an object corresponding to a leading (or preceding) vehicle, a road sign, a traffic control apparatus, or the like is recognized. Then, a position within the color image (i.e., a pixel position on vertical and horizontal axes of the color image) is extracted with respect to each of the recognized objects.

Furthermore, from the image photographed by the camera 104b, an eye point of the user seated on a driver seat of the subject vehicle is detected, and then based on the detected eye point, a given position on the display area in the windshield 101 is designated. Here, the given position corresponds to, within the color image, the pixel position of the object having the red light element.

The vehicle display system 100 generates a display image for highlighting the position of the object having the red light element, on the display area in the windshield 101, based on a display image stored in the image information database 305b, to display the generated display image on the designated position in the windshield 101.

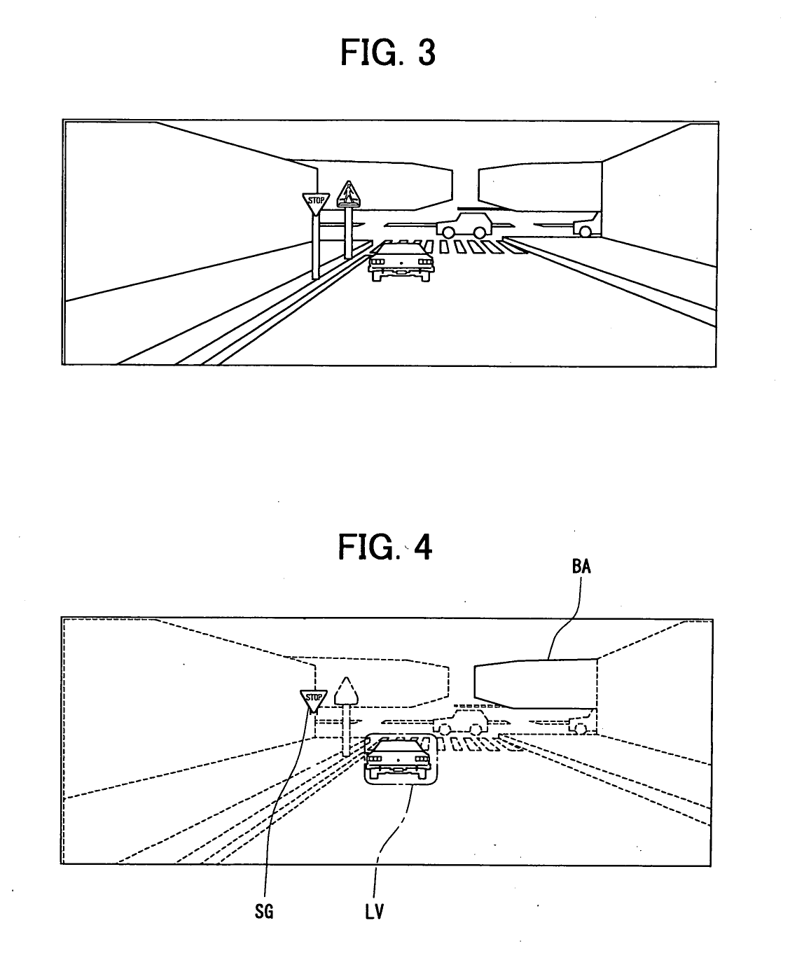

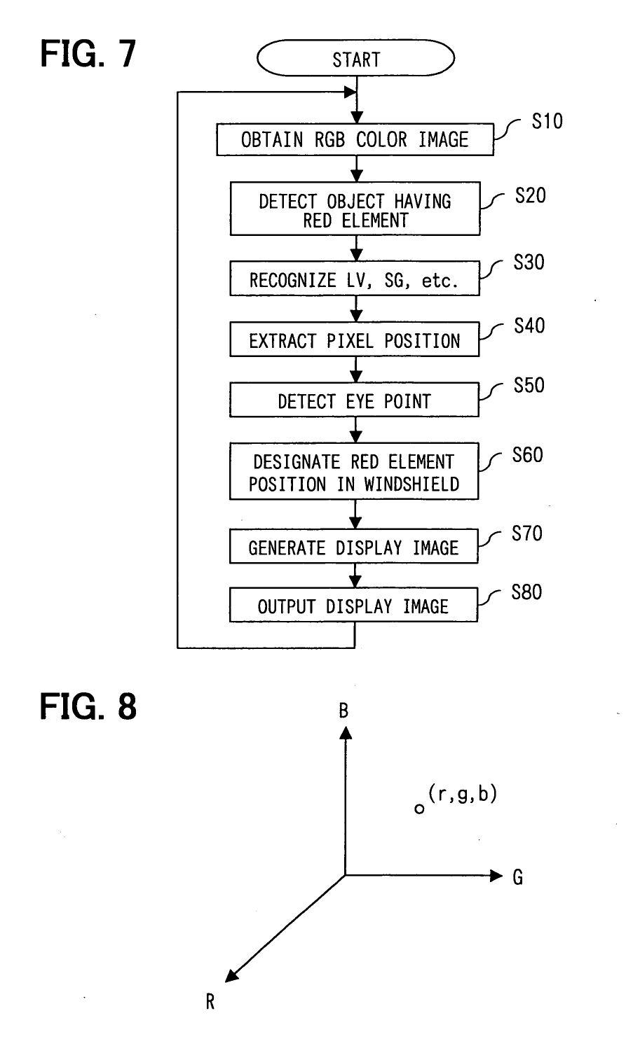

Next, the process of the vehicle display system 100 will be explained with reference to FIG. 7 showing a flow chart of the process. First, at Step S10, an RGB color image is obtained from the camera 104a. For instance, the RGB color image of a forward scenery ahead of the subject vehicle shown in FIG. 3 is obtained.

At Step S20, objects having red light elements are detected from the obtained RGB color image. Here, the detected object possesses a given combination (r, g, b) of red (R), green (G), and blue (B). In this given combination, the red light element is a given value or more while the green element and the blue element are less than given values. For instance, as shown in FIG. 4, a leading vehicle (LV) having red light elements of the brake lights, a halt sign (SG), and a barrier wall (BA) painted in red are detected.

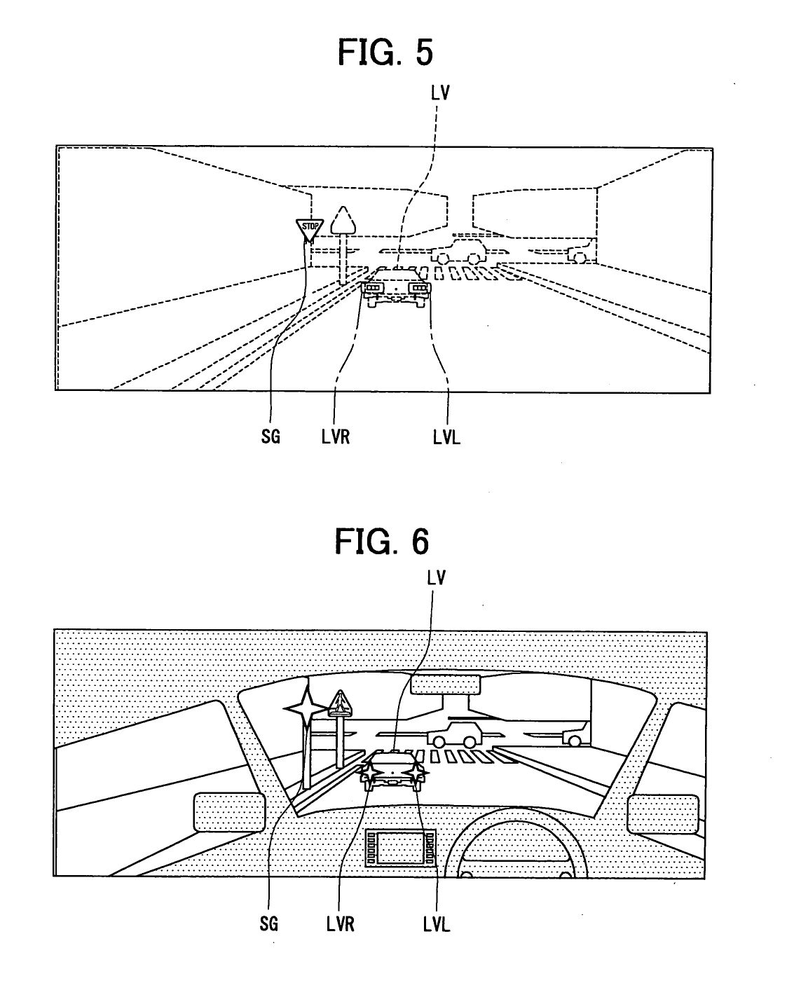

At Step S30, of the objects having the red light elements detected at Step S20, an object corresponding to a leading vehicle, a road sign, or a traffic control apparatus is recognized. Recognizing the leading vehicle can be performed not only based on the shape of the vehicle, but also based on a measurement result of the laser radar 105, resulting in enhancement of recognition accuracy. Further, recognizing the road sign or the traffic control apparatus is performed by the following: designating a current position of the subject vehicle based on signals from the GPS satellites received by the GPS antenna 106; obtaining an advancing orientation at the designated position of the subject vehicle, from the azimuth sensor 108; obtaining road signs and the traffic control apparatuses located along the advancing orientation from the map database 305a; and recognizing whether a forward object having a red light element is a road sign or a traffic control apparatus lighting a red traffic signal. By virtue of the processing at Step S30, brake lights LVL, LVR disposed at a left end and a right end of the rear of the leading vehicle LV, and a halt sign SG are recognized, as shown in FIG. 5.

At Step S40, with respect to at least one of the leading vehicle, the road sign, and the traffic control apparatus recognized as the objects having the red light elements, a position (pixel position) in the RGB color image is extracted.

At Step S50, from the image photographed by the camera 104b, an eye point of the user seated on the driver seat of the subject vehicle is detected.

At Step S60, based on the eye point of the user detected at Step S50, a position of a red light element on the display area within the windshield 101 is designated.

At Step S70, a display image is generated for highlighting the position of the red light element on the display area in the windshield 101. For instance, a given display image is extracted from display image data stored in the image information database 305b.

At Step S80, the display image generated at Step S70 is displayed in the position of the red light element, which is designated at Step S60, on the display area in the windshield 101. This highlights the brake lights LVL, LVR that are disposed at the left and right ends of the rear of the leading vehicle LV, the halt sign SG, so that the user of the subject vehicle can easily recognize them.

As explained above, the vehicle display system 100 of the embodiment, recognizes the leading vehicle, the road sign, and the traffic control apparatus, all of which possess the red light elements in the camera image of the forward scenery taken by the camera, and displays the recognized objects having the red light elements by highlighting the position of the recognized object on the display area in the windshield 101.

This results in proper user's recognition of the brake lights of the leading vehicle, the road signs such as the halt sign, and do-not-enter sign, and the traffic control apparatus with the red traffic signal lighting, all of which mainly include “red” that indicates the information important to the driving. Consequently, an effect is expected that prevents the user of the subject vehicle from missing recognizing the information important to the driving.

(Modification 1)

In the above embodiment, the vehicle display system 100 displays a display image for highlighting, on a display area in the windshield 101 of the subject vehicle. However, the system 100 can be differently constructed. For instance, a color image of a forward scenery ahead of the subject vehicle can be displayed on a display screen 120 (shown in FIGS. 1, 2) disposed around a center console or a head-up display having a display area defined in a part of the windshield 101 while the display image for highlighting is superimposed over the color image of the forward scenery.

This enables the user to properly recognize the brake lights of the leading vehicle, the road signs such as the halt sign, and do-not-enter sign, and the traffic control apparatus with the red traffic signal lighting, all of which mainly include “red” that indicates the information important to the driving.

(Modification 2)

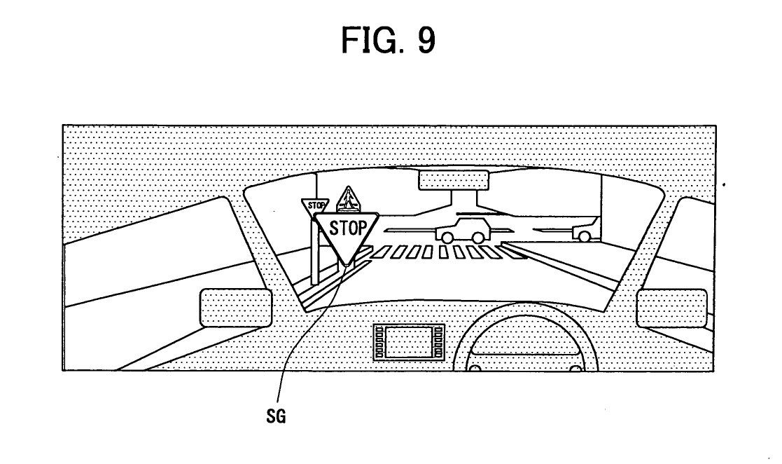

In the above embodiment, the vehicle display system 100 displays a cross-shape, as shown in FIG. 6, as a display image for highlighting. However, the display image for highlighting can be generated differently. For instance, a display image that indicates a position can be displayed with a red light element having a brightness more than that of the forward scenery. Further, as shown in FIG. 9, a display image can be displayed by magnifying the object having a red light element such as a halt sign (SG). Yet further, a display image can be displayed by blinking the position having a red light element. In this structure, the red light element is highlighted on the windshield of the subject vehicle, so that the user can be provided with the information important to the driving.

Furthermore, in the modification 1, the display image superimposed on the displayed color image of the forward scenery can be displayed so that the display image possesses a red light element having a brightness more than that of the displayed color image of the forward scenery. Further, similarly, a display image can be displayed by magnifying the object having a red light element. Yet further, a display image can be displayed by blinking the position having a red light element.

(Modification 3)

For instance, generally, viewing, in the daytime, lighting of the brake lights of the leading vehicle or lighting of the red traffic signal of the traffic control apparatus is more difficult than in the nighttime. This phenomenon remarkably takes place, in particular, when a sun light directly advances to the subject vehicle around the morning or twilight. By contrast, in the nighttime, the lighting of the brake lights of the leading vehicle or the lighting of the red traffic signal of the traffic control apparatus can be recognized without any highlighting.

Consequently, it is preferable that a display image for highlighting is preferentially provided when the brightness of the forward scenery is a given level or more. Thus, the user who is in a state where the corresponding object is difficult to be recognize is properly provided with the information important to driving.

(Modification 4)

In the above embodiment, the vehicle display system 100 does not consider whether the user already recognizes the leading vehicle, the road sign, or the traffic control apparatus. Therefore, even when the user already recognizes them, the position of the red light element is highlighted, resulting in bothering the user.

To solve this problem, a vehicle display system can be provided with a sight line detecting unit 130 (shown in FIGS. 1, 2) that detects a sight line of the user and an object designating unit that designates an object that the user sees based on the detected sight line and the taken color image of the forward scenery. In this structure, an object that is designated by the object designating unit is excluded from the object whose position is highlighted, resulting in decreasing the user's bothering.

Further, to achieve the modification 4, for instance, by adopting, as the sight line detecting unit, an infrared floodlight lamp, an infrared floodlight region photographing camera, a viewing point sensor, all of which are disclosed in JP-2001-357498 A, a user's viewing point on the display area in the windshield can be detected. An object located at the viewing point on the display area in the windshield 101 is thereby designated, so that the designated object can be excluded from the object whose position is to be highlighted.

It will be obvious to those skilled in the art that various changes may be made in the above-described embodiments of the present invention. However, the scope of the present invention should be determined by the following claims.

1. A vehicle display system comprising:
an image taking unit that takes a color image of a forward scenery ahead of a vehicle;
an object detecting unit that detects an object including a red light element in the taken color image of the forward scenery;
an object recognizing unit that recognizes, of the detected object, an object corresponding to at least one of a leading vehicle, a road sign, and a traffic control apparatus;
an extracting unit that extracts, of the red light element of the recognized object, a first position on the taken color image of the forward scenery;
a displaying unit that includes a display area in a windshield of the vehicle, and displays on the display area a display image that is superimposed on the forward scenery, to thereby cause a user of the vehicle to recognize the display image;
an eye point detecting unit that detects an eye point of the user;
a position designating unit that designates a second position on the display area corresponding to the extracted first position of the red light element based on a result of detecting by the eye point detecting unit;
a display image generating unit that generates the display image that is used to highlight the designated second position over the forward scenery; and
a display controlling unit that displays the generated display image at the designated second position on the display area.

2. The vehicle display system of claim 1,
wherein the display image generating unit generates the display image that is at least one of
an image that indicates the designated second position with a brightness that exceeds a brightness of the forward scenery,
an image that is formed by magnifying the recognized object including the red light element, and
a blinking image that indicates the designated second position.

3. The vehicle display system of claim 1,
wherein the display control unit displays the generated display image when a brightness of the forward scenery is a given brightness or brighter.

4. The vehicle display system of claim 1, further comprising:
a sight line detecting unit that detects a sight line of the user; and
an object designating unit that designates an object that the user sees based on the detected sight line and the taken color image,
wherein the object recognizing unit that recognizes an object excluding the object designating by the object designating unit.

5. A vehicle display system comprising:
an image taking unit that takes a color image of a forward scenery ahead of a vehicle;
an object detecting unit that detects an object including a red light element in the taken color image of the forward scenery;
an object recognizing unit that recognizes, of the detected object, an object corresponding to at least one of a leading vehicle, a road sign, and a traffic control apparatus;
an extracting unit that extracts, of the red light element of the recognized object, a first position on the taken color image of the forward scenery;
a displaying unit that displays the taken color image;
a display image generating unit that generates a display image used to highlight the extracted first position over the forward scenery within the color image displayed by the displaying unit; and
a display controlling unit that displays the generated display image that is superimposed over the extracted first position.

6. The vehicle display system of claim 5,
wherein the display image generating unit generates the display image that is at least one of
an image that indicates the extracted first position with a brightness that exceeds a brightness of the displayed forward scenery,
an image that is formed by magnifying the recognized object including the red light element, and
a blinking image that indicates the extracted first position.

7. The vehicle display system of claim 5,
wherein the display control unit displays the generated display image when a brightness of the forward scenery is a given brightness or brighter.

8. The vehicle display system of claim 5, further comprising:
a sight line detecting unit that detects a sight line of the user; and
an object designating unit that designates an object that the user sees based on the detected sight line and the taken color image,
wherein the object recognizing unit that recognizes an object excluding the object designating by the object designating unit.

9. A displaying method used in a vehicle display system, the method comprising steps of:
taking a color image of a forward scenery ahead of a vehicle;
detecting an object including a red light element in the taken color image of the forward scenery;
recognizing, of the detected object, an object corresponding to at least one of a leading vehicle, a road sign, and a traffic control apparatus;
extracting, of the red light element of the recognized object, a first position on the taken color image of the forward scenery;
detecting an eye point of a user of the vehicle;
designating a second position that is located on a display area in a windshield of the vehicle and corresponds to the extracted first position of the red light element based on the detected eye point;
generating a display image that is used to highlight the designated second position over the forward scenery; and
displaying, at the designated second position on the display area, the generated display image that is superimposed on the forward scenery, to thereby cause the user of the vehicle to recognize the display image.

10. A displaying method used in a vehicle display system, the method comprising steps of:
taking a color image of a forward scenery ahead of a vehicle;
detecting an object including a red light element in the taken color image of the forward scenery;
recognizing, of the detected object, an object corresponding to at least one of a leading vehicle, a road sign, and a traffic control apparatus;
extracting, of the red light element of the recognized object, a first position on the taken color image of the forward scenery;
generating a display image used to highlight the extracted first position over the forward scenery within the color image; and
displaying the taken color image and the generated display image so that the generated display image is superimposed over the extracted first position on the displayed color image.
